(19) United States
(12) Patent Application Publication
(10) Pub. No.: US 2005/0081090 A1
(43) Pub. Date: Apr. 14, 2005

(54) Method for automatically and safely recovering BIOS memory circuit in memory device including double BIOS memory circuits

(75) Inventor: Huo-Yuan Lin, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Giga-Byte Technology Co., Ltd., Sindian City (TW)

(21) Appl. No.: 10/674,197

(22) Filed: Sep. 29, 2003

(51) Int. Cl. G06F 11/00

(52) U.S. Cl. 714/6

(57) ABSTRACT

A method for recovering a basic input/output system (BIOS) memory circuit in a computer system is disclosed. The method includes steps of providing a memory device comprising a first basic input/output system memory circuit and a second basic input/output system memory circuit, the first basic input/output system memory circuit and the second basic input/output system memory circuit respectively having a first computer program and a second computer program stored therein, wherein the first basic input/output system memory circuit and the second basic input/output system memory circuit are employed to initiate an operation of the computer system, enabling the second basic input/output system memory circuit upon booting the computer system, detecting if the first computer program includes an error, and re-programming the first basic input/output system memory circuit based on the second computer program when the error is detected in the first computer program.

### FIELD OF THE INVENTION

This invention relates to a memory device including double BIOS memory circuits in a computer system, and more particularly to a method of recovering a main BIOS memory circuit upon a safe recovery BIOS memory circuit in the memory device for preventing a boot failure caused by an operation error as booting a computer system.

### BACKGROUND OF THE INVENTION

In the current computer framework, the so-called BIOS (Basic Input/Output System) is a most basic software for basic computer operation. And, BIOS is mainly composed of low-level instruction set for providing the basic hardware test, computer definition and basic operations, e.g., performing a self test, annotating signals from the keyboard and sending information among ports when booting the computer system. Therefore, all the operations as firstly booting the computer are performed based upon the contents of BIOS. Consequently, if there comes an error in BIOS, the computer will be unable to perform tests of a RAM (Random-Access Memory), a HD (Hard Disk) and a CPU (Central Processing Unit), for example, as booting, and thus the computer will not be successfully booted.

Also, because BIOS plays such an important role in the computer system, generally, the program instruction set of BIOS is burned in a memory, which is capable of lacking power source for a long time, such as Flash ROM (Read Only Memory), PROM (Programmable Read-Only Memory), EPROM (Erasable Programmable Read Only Memory) and EEPROM (Electrically Erasable Programmable Read-Only Memory). And, this BIOS memory is built-in the mother board or the chipset of the computer system so that the contents thereof will not be influenced by power supply and can be reserved forever.

However, the contents of BIOS are still difficult to maintain no error. When the circuit structure of the BIOS memory appears degradation as time going by or is influenced by unpredictable operations, the contents thereof might be lost or produces some errors. Then, this situation will cause an error in performing BIOS program instruction set as booting and further result in unsuccessful booting procedure.

Consequently, for dealing with the technical situation described above, the applicant keeps on carving unflaggingly to develop a “method for automatically and safely recovering bios memory circuit in memory device including double bios memory circuits” through wholehearted experience and research.

### SUMMARY OF THE INVENTION

It is an object of the present invention to develop a method for automatically recovering a BIOS memory circuit used in a memory chip/device including a main BIO memory circuit and a safe recovery memory circuit in a computer system.

It is another object of the present invention to provide a method for safely recovering a defective main BIOS memory circuit as booting so that the computer still can be booted via the main BIOS memory circuit.

According to an aspect of the present invention, a method for recovering a basic input/output system (BIOS) memory circuit in a computer system includes steps of providing a memory device comprising a first basic input/output system memory circuit and a second basic input/output system memory circuit, the first basic input/output system memory circuit and the second basic input/output system memory circuit respectively having a first computer program and a second computer program stored therein, wherein the first basic input/output system memory circuit and the second basic input/output system memory circuit are employed to initiate an operation of the computer system, enabling the second basic input/output system memory circuit upon booting the computer system, detecting if the first computer program includes an error, and re-programming the first basic input/output system memory circuit based on the second computer program when the error is detected in the first computer program.

Preferably, the first computer program and the second computer program can be identical or different.

Preferably, the enabling step further includes steps of providing a chip enabling circuit having a chip enabling control terminal, and enabling the second BIOS memory circuit through the chip enabling control terminal of the chip enabling circuit upon booting the computer system.

Preferably, the chip enabling control terminal is a general purpose input/output pin (GPIO pin).

Preferably, the detecting step further includes steps of providing an error-detecting circuit, and checking an error-detecting data value contained in the first computer program through the error-detecting circuit for determining if the first computer program includes the error.

Preferably, the error-detecting data value is a checksum data value, a parity check data value or a cyclic redundancy check (CRC) data value.

Preferably, the first basic input/output system memory circuit further includes a flash utility for reprogramming the first basic input/output system memory circuit based on the second computer program.

Preferably, the second basic input/output system memory circuit further comprises a flash utility for reprogramming the first basic input/output system memory circuit based on the second computer program.

In accordance with an aspect of the present invention, a method for initiating a computer system includes steps of providing a memory chip comprising a first basic input/output system memory circuit and a second basic input/output system memory circuit, the first basic input/output system memory circuit and the second basic input/output system memory circuit respectively having a first computer program and a second computer program stored therein, wherein the first basic input/output system memory circuit and the second basic input/output system memory circuit are employed to initiate an operation of the computer system, enabling the second basic input/output system memory circuit upon booting the computer system, detecting if the first computer program includes an error, re-programming the first basic input/output system memory circuit based on the second computer program when the error is detected in the first computer program, enabling the first basic input/output system memory circuit and disabling the second basic input/output system memory circuit, and initiating an operation of the computer system through the first basic input/output system memory circuit.

Preferably, the first computer program and the second computer program can be identical or different.

Preferably, the step of enabling the second BIOS memory circuit further includes steps of providing a chip enabling circuit having a chip enabling control terminal, and enabling the second BIOS memory circuit through the chip enabling control terminal of the chip enabling circuit upon booting the computer system.

Preferably, the chip enabling control terminal is a general purpose input/output pin (GPIO pin).

Preferably, the detecting step further includes steps of providing an error-detecting circuit, and checking an error-detecting data value contained in the first computer program through the error-detecting circuit for determining if the first computer program includes the error.

Preferably, the error-detecting data value is a checksum data value, a parity check data value or is a cyclic redundancy check (CRC) data value.

Preferably, the first basic input/output system memory circuit further comprises a flash utility for reprogramming the first basic input/output system memory circuit based on the second computer program.

Preferably, the second basic input/output system memory circuit further comprises a flash utility for reprogramming the first basic input/output system memory circuit based on the second computer pro-ram.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIGS. 1 is a functional block chart showing a BIOS memory device with double BIOS memory circuits in a computer system in a preferred embodiment according to the present invention; and

FIG. 2 is a flow chart of an automatic and safe recovery method for a BIOS memory circuit in a computer system in a preferred embodiment according to the present invention.

### DETAILED DESCRIPTION OF THE PREFERRED EMBODIMENT

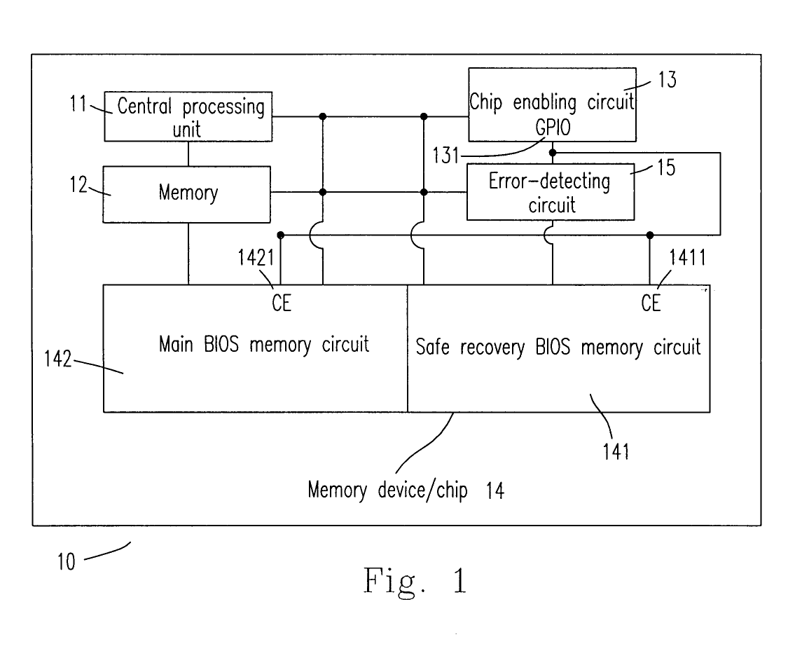

Please refer to FIG. 1 showing a preferred embodiment according to the present invention. This embodiment illustrates a computer system 10 includes a central processing unit 11, a memory 12, a chip enabling circuit 13, an error-detecting circuit 15 and a BIOS memory chip/device 14 with double BIOS memory circuit 141 and 142. The BIOS memory device/device 14 is an ASIC (Application Specific Integrated Circuit) chip combining two BIOS memory circuits so that the computer system 10 will own two BIOSs. Meanwhile, the BIOS memory device 14 can be composed of an EPROM or an EEPROM.

The BIOS memory device 14 includes two BIOS memory circuits; one is a main BIOS memory circuit 142 and the other is a safe recovery BIOS memory circuit 141. The BIOS programs respectively stored in the main BIOS memory circuit 142 and the safe recovery BIOS memory circuit 141 can be identical or different, and these two BIOS programs are both composed of the program instruction set for initiating the operation of the computer system 10. In order to recover the BIOS program stored in the main BIOS memory circuit 142 as being detected to notice an error, the main BIOS memory circuit 142 or the safe recovery BIOS memory circuit 141 further comprises a flash utility for reprogramming the main BIOS memory circuit 142 upon the BIOS program stored in the safe recovery BIOS memory circuit 141 so as to recover the contents of main BIOS memory circuit 142.

Moreover, the chip enabling circuit 13 comprises a chip enabling control terminal 131, which can be achieved, for example, through a GPIO pin (General Purpose Input/Output pin) 131, for outputting an enable signal to a chip enable (CE) pin 1421 of the main BIOS memory circuit 142 and a chip enable (CE) pin 1411 of the safe recovery BIOS memory circuit 141 so as to switch to the BIOS memory circuit to be enabled.

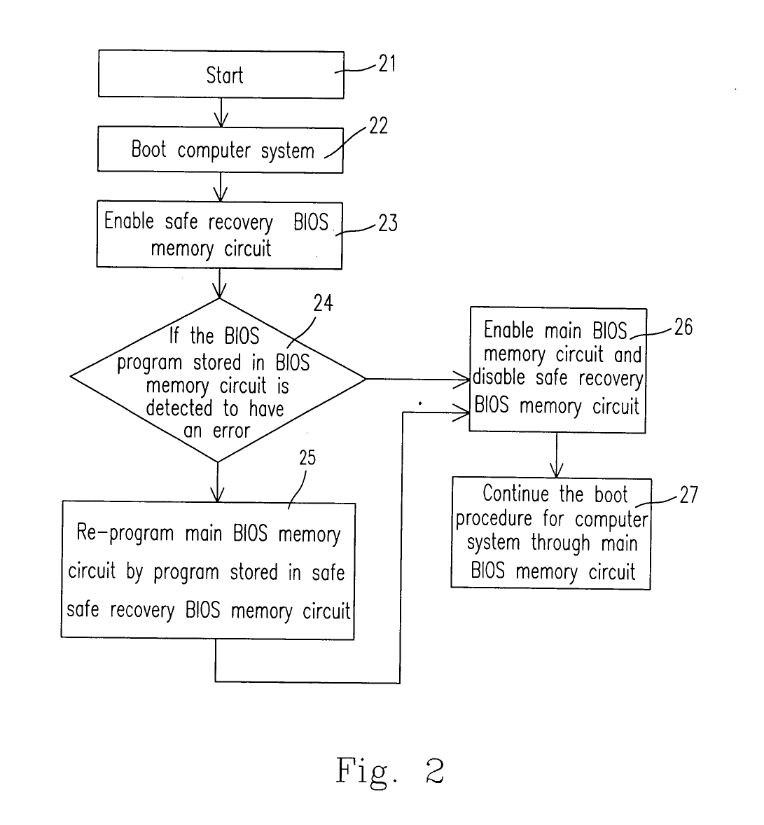

One preferred embodiment of the method for automatically and safely recovering the BIOS memory circuit in a computer system according to the present invention can be adequately understood through the flow chart illustrated in FIG. 2. Please refer to FIG. 2, which is started from step 21. After the computer system is booted (step 22), the GPIO pin of the chip enabling circuit will enable the safe recovery BIOS memory circuit (step 23). At this time, the error-detecting circuit in the computer system will check that if the BIOS program in the main BIOS memory circuit includes an error judgment 24). Here, the error detection of contents of the main BIOS memory circuit can be determined by checking if a checksum data value, a parity check data value or a CRC (Cyclic Redundancy Check) data value of a predetermined memory address of the main BIOS memory circuit is correct. If it does not detect any error contained in the contents of the main BIOS memory circuit, the GPIO pin of the chip enabling circuit will disable the safe recovery BIOS memory circuit and enable the main BIOS memory circuit (step 26). Thus, the operation of booting will be processed via the main BIOS memory circuit (step 27). Oppositely, if it detects an error contained in the contents of the main BIOS memory circuit, the flash utility stored in the main BIOS memory circuit or the safe recovery BIOS memory circuit will be performed so as to re-program the main BIOS memory circuit upon the BIOS program stored in the safe recovery BIOS memory circuit (step 25). By the time the main BIOS memory circuit is recovered, the GPIO pin of the chip enabling circuit will disable the safe recovery BIOS memory circuit and enable the main BIOS memory circuit (step 26) and the operation of booting still can be processed via the main BIOS memory circuit (step 27). Therefore, the booting procedure of the computer can be completed successfully and still maintain uninfluenced even the error is detected in the contents of the main BIOS memory circuit.

In view of aforesaid, the present invention integrates two BIOS memory circuits, which are respectively a main BIOS memory circuit and a safe recovery BIOS memory circuit both with a BIOS program stored therein, in an ASIC chip (Application Specific Integrated Circuit) and employs a safe recovery BIOS memory circuit to be a safe recovery circuit for the main BIOS memory circuit when an error is detected in the main BIOS memory circuit. Furthermore, a flash utility is also stored in one of the main BIOS memory circuit or the safe recovery BIOS memory circuit. Thus, when the contents of the main BIOS memory circuit is detected to have an error contained therein, the contents of the main BIOS memory can be recovered upon the BIOS program stored in the safe recovery BIOS memory circuit through performing the flash utility. Therefore, the method according to the present invention can prevent an unsuccessful booting when an error is happened in a processing BIOS program so as to successfully continue the computer initiation. Consequently, the present invention is truly a practical creation for the related industries.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for recovering a basic input/output system (BIOS) memory circuit in a computer system, comprising steps of:
providing a memory device comprising a first basic input/output system memory circuit and a second basic input/output system memory circuit, said first basic input/output system memory circuit and said second basic input/output system memory circuit respectively having a first computer program and a second computer program stored therein, wherein said first basic input/output system memory circuit and said second basic input/output system memory circuit are employed to initiate an operation of said computer system;
enabling said second basic input/output system memory circuit upon booting said computer system;
detecting if said first computer program includes an error; and
re-programming said first basic input/output system memory circuit based on said second computer program when said error is detected in said first computer program.

2. A method according to claim 1 wherein said first computer program and said second computer program are identical.

3. A method according to claim 1 wherein said first computer program and said second computer program are different.

4. A method according to claim 1 wherein said enabling step further comprises steps of:
providing a chip enabling circuit having a chip enabling control terminal; and
enabling said second BIOS memory circuit through said chip enabling control terminal of said chip enabling circuit upon booting said computer system.

5. A method according to claim 4 wherein said chip enabling control terminal is a general purpose input/output pin (GPIO pin).

6. A method according to claim 1 wherein said detecting step further comprises steps of:
providing an error-detecting circuit; and
checking an error-detecting data value contained in said first computer program through said error-detecting circuit for determining if said first computer program includes said error.

7. A method according to claim 6 wherein said error-detecting data value is a checksum data value.

8. A method according to claim 6 wherein said error-detecting data value is a parity check data value.

9. A method according to claim 6 wherein said error-detecting data value is a cyclic redundancy check (CRC) data value.

10. A method according to claim 1 wherein said first basic input/output system memory circuit further comprises a flash utility for reprogramming said first basic input/output system memory circuit based on said second computer program.

11. A method according to claim 1 wherein said second basic input/output system memory circuit further comprises a flash utility for reprogramming said first basic input/output system memory circuit based on said second computer program.

12. A method for initiating a computer system, comprising steps of:
providing a memory chip comprising a first basic input/output system memory circuit and a second basic input/output system memory circuit, said first basic input/output system memory circuit and said second basic input/output system memory circuit respectively having a first computer program and a second computer program stored therein, wherein said first basic input/output system memory circuit and said second basic input/output system memory circuit are employed to initiate an operation of said computer system;
enabling said second basic input/output system memory circuit upon booting said computer system;
detecting if said first computer program includes an error;
re-programming said first basic input/output system memory circuit based on said second computer program when said error is detected in said first computer program;
enabling said first basic input/output system memory circuit and disabling said second basic input/output system memory circuit; and
initiating an operation of said computer system through said first basic input/output system memory circuit.

13. A method according to claim 12 wherein said first computer program and said second computer program are identical.

14. A method according to claim 12 wherein said first computer program and said second computer program are different.

15. A method according to claim 12 wherein said step of enabling said second BIOS memory circuit further comprises steps of:
providing a chip enabling circuit having a chip enabling control terminal; and
enabling said second BIOS memory circuit through said chip enabling control terminal of said chip enabling circuit upon booting said computer system.

16. A method according to claim 15 wherein said chip enabling control terminal is a general purpose input/output pin (GPIO pin).

17. A method according to claim 12 wherein said detecting step further comprises steps of:
providing an error-detecting circuit; and
checking an error-detecting data value contained in said first computer program through said error-detecting circuit for determining if said first computer program includes said error.

18. A method according to claim 17 wherein said error-detecting data value is a checksum data value.

19. A method according to claim 17 wherein said error-detecting data value is a parity check data value.

20. A method according to claim 17 wherein said error-detecting data value is a cyclic redundancy check (CRC) data value.

21. A method according to claim 12 wherein said first basic input/output system memory circuit further comprises a flash utility for reprogramming said first basic input/output system memory circuit based on said second computer program.

22. A method according to claim 12 wherein said second basic input/output system memory circuit further comprises a flash utility for reprogramming said first basic input/output system memory circuit based on said second computer program.
